(19) United States
(12) Patent Application Publication
(10) Pub. No.: US 2025/0260490 A1
(43) Pub. Date: Aug. 14, 2025

(54) INTEGRATING EDGE COMPUTE INTO OPTICAL PASSIVE INFRASTRUCTURE

(71) Applicant: AFL Telecommunications LLC, Duncan, SC (US)

(72) Inventor: Sean Patrick Adam, Wrentham, MA (US)

(21) Appl. No.: 18/867,107

(22) PCT Filed: May 18, 2023
(86) PCT No.: PCT/US2023/022734

§ 371 Date: Nov. 19, 2024

Related U.S. Application Data
(60) Provisional application No. 63/344,237, filed on May 20, 2022.

(51) Int. Cl. H04B 10/27; G02B 6/44; H04B 10/25

(52) U.S. Cl. CPC H04B 10/27; G02B 6/44528; H04B 10/25

(57) ABSTRACT

Optical networks including edge compute nodes disposed in enclosures along passive optical networks are provided. An enclosure for a passive optical network includes a housing selectively enclosing an internal volume which houses one or more passive optical components; and an edge compute node disposed in the internal volume and configured to be in optical communication with an optical line terminal and an optical network unit of the optical fiber network.

### CROSS-REFERENCE TO RELATED APPLICATIONS

The present application claims priority to U.S. Provisional Patent Application Ser. No. 63/344,237 filed on May 20, 2022, the disclosure of which is incorporated by reference herein in its entirety.

### FIELD

The present disclosure relates generally to edge compute nodes, and more particularly, to integrating edge compute into optical passive infrastructure associated with optical networks.

### BACKGROUND

Optical networks, such as passive optical networks (PONs), point to point (P2P), and hybrid-fiber coax networks allow for delivery of broadband network access to one or more customers. By way of example, PON architecture utilizes a point-to-multipoint topology where multiple customers are connected to a single point using unpowered (passive) optical hardware which splits a fiber bandwidth among the customers. PONs utilize an optical line terminal (OLT) at a service provider's central office and optical network terminals (ONTs) near customer locations. Passive optical splitters between the OLT and the ONTs split the signal to route specified data to each ONT. Downstream signals are sent from the OLT, through the PON, and arrive at the ONTs. Conversely, upstream signals are sent from the ONTs, through the PON, and arrive at the OLT. As broadband demand increases, the information density transmitted within the PON increases. Moreover, as access to the PON is stretched over greater distances, e.g., further into rural areas, latency increases.

Accordingly, improved optical network architecture is desired in the art. In particular, optical network architecture which provides reduced latency and increased under user processing performance and customer experience would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, an optical fiber network is provided. The optical fiber network includes an optical line terminal; an optical network unit; an optical fiber network extending between the optical line terminal and the optical network unit; an enclosure disposed along the optical fiber network, wherein the enclosure comprises: a base; a cover, wherein the base and cover selectively enclose an internal volume of the enclosure; a tray disposed in the internal volume; and an edge compute node coupled to the tray and in optical communication with the optical line terminal and the optical network unit.

In accordance with another embodiment, an enclosure for an optical fiber network is provided. The enclosure includes a housing selectively enclosing an internal volume which houses one or more passive optical components; and an edge compute node disposed in the internal volume and configured to be in optical communication with an optical line terminal and an optical network unit of the optical fiber network.

In accordance with another embodiment, a method of upgrading an optical fiber network is provided. The method includes accessing an internal volume of an enclosure disposed along the optical fiber network, wherein the enclosure houses one or more passive optical components; installing an edge compute node within the internal volume; and routing power to the internal volume to power the edge compute node.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1A illustrates a schematic view of an optical network in accordance with embodiments of the present disclosure;

FIG. 1B illustrates a schematic view of a passive optical network in accordance with embodiments of the present disclosure;

FIG. 2 illustrates an enclosure disposed in the passive optical network in accordance with embodiments of the present disclosure;

FIG. 3 illustrates an internal volume of the enclosure with a cover removed in accordance with embodiments of the present disclosure;

FIG. 4 illustrates an internal volume of the enclosure with a cover removed in accordance with embodiments of the present disclosure;

FIG. 5 illustrates a schematic view of a remote computing network in accordance with embodiments of the present disclosure;

FIG. 6 illustrates a flowchart of a method of upgrading an optical fiber network by retrofitting an edge compute node into an existing enclosure in accordance with embodiments of the present disclosure;

FIG. 7 illustrates an enlarged view of a portion of a tray for use with an enclosure in accordance with embodiments of the present disclosure;

FIG. 8 illustrates a cross-sectional view of an edge compute node cover for the enclosure in accordance with embodiments of the present disclosure as seen along Line A-A in FIG. 3; and

FIG. 9 illustrates an enclosure having ruggedized connectors in accordance with exemplary embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, edge compute nodes capable of performing computational processing are incorporated into optical networks in accordance with embodiments described herein. More particularly, the edge compute nodes are incorporated into enclosures within optical networks. As the enclosures are located closer to the end user than remote processors and storage devices traditionally used for remote processing, the edge compute nodes offer lower broadband latency and reduce strain on the broadband network which is vital moving forward as device interconnectivity continues to grow and autonomous systems are integrated with one another at scale. Moreover, given the high density of enclosures already distributed in the field as part of optical networks, retrofitting existing enclosures is contemplated herein to reduce costs associated with setting up new enclosures, to increase installation efficiency and reduce installation time, and to provide a more robust broadband network with lower latency.

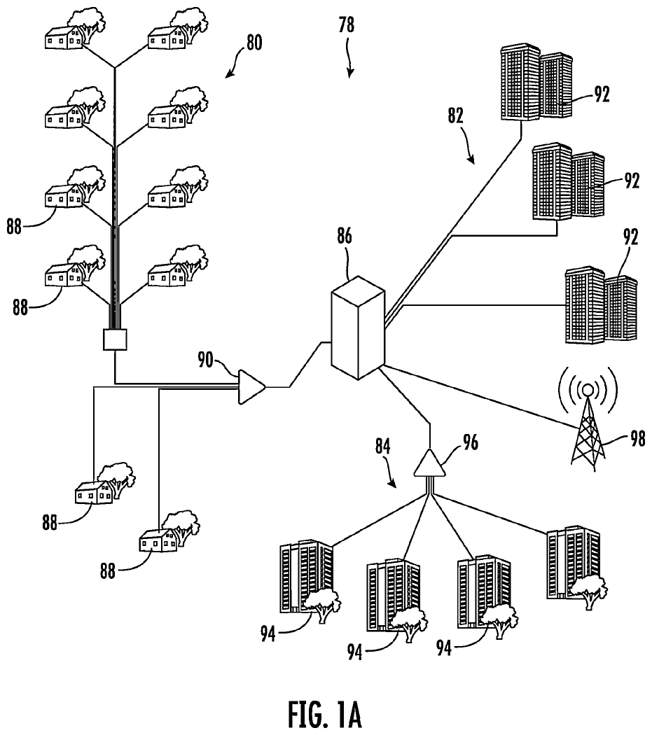

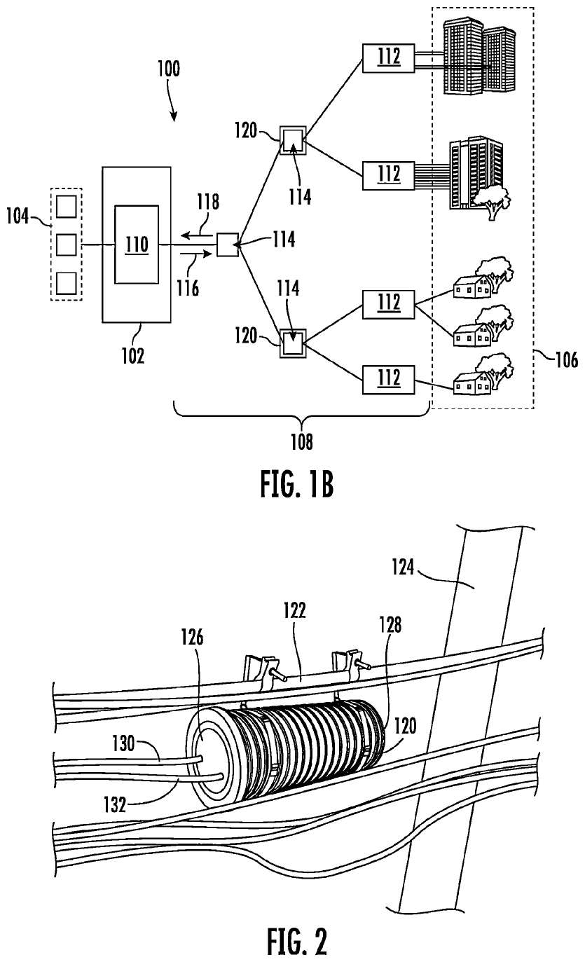

Referring now to the drawings, FIG. 1A illustrates an exemplary optical network 78 depicting a plurality of different optical deployments in accordance with exemplary embodiments. The optical deployments include a passive optical network (PON) 80, a point to point (P2P) network 82, and a hybrid-fiber coax network 84. All of the optical deployments are coupled to a central office 86 and extend to different end points. The PON 80 is shown providing broadband access to a plurality of homes 88 utilizing a passive optical component 90, e.g., a splitter disposed in an enclosure. The P2P 82 is shown providing broadband access to a plurality of office buildings 92. The hybrid-fiber coax network 84 is shown providing broadband access to a plurality of multi-unit residential buildings 94 utilizing a passive optical component 96, e.g., a fiber to copper converter disposed in an enclosure. In an embodiment, the central office 86 can further be coupled to other equipment, such as an antenna 98 or endpoint hardware. The antenna 98 is shown in a point-to-point arrangement where data is transmitted from the central office 86 to the antenna 98. Yet other arrangements and optical deployments are possible.

FIG. 1B illustrates a schematic view of a PON 100 as seen in accordance with an exemplary embodiment. While reference with respect to certain embodiments are made in view of the PON 100, it should be understood that the embodiments described herein may alternatively, or additionally, utilize other optical deployment architecture and arrangements including, e.g., P2P, hybrid-fiber coax, wireless networks, cloud radio access network (C-RAN), other architectural arrangements, and combinations thereof. The optical architecture may be point-to-point or point-to-multipoint.

The illustrated PON 100 includes a central office 102 forming an upstream end of the PON 100. The central office 102 sends data from one or more sources 104 to end users (customers) 106 through an optical distribution network (ODN) 108. The end users 106 can include, for example, residential buildings such as single-family homes or apartment buildings, commercial buildings, or the like. Each end user 106 is optically coupled to the ODN 108 to receive information from the sources 104 through the central office 102. The sources 104 can include, for example, corporate servers and storage devices, outside telecommunication connections like public switched telephone network (PSTN), community antenna television (CATV), internet protocol television (IPTV), video on demand (VOD), multiprotocol label switching (MPLS), or the like.

The central office 102 includes an optical line terminal (OLT) 110 in communication with the sources 104. The OLT 110 acts as an endpoint to the ODN 108. The OLT 110 can generally include a central processing unit (CPU), a passive optical network card, a gateway router, a voice gateway uplink card, or other components. The OLT 110 receives information from the sources 104 (typically in the form of electrical signals), converts the information into optical signals, and transmits the optical signals into the ODN 108. The optical signals travel through the ODN 108 and arrive at optical network units (ONU) 112 associated with the end users 106. In some instances, at least some of the ONUs 112 can correspond to individual dwellings or residences. In other instances, the ONUs 112 can be shared between residences, between buildings, or the like.

The ODN 108 includes passive optical components 114 distributed throughout the ODN 108. The passive optical components 114 can include, for example, splitters, splice trays, adapters, connectors, couplers, attenuators, isolators, circulators, filters, switches, optical add/drop multiplexers, and the like. The passive optical components 114 facilitate distribution of the optical signals between the OLT 110 and the ONUs 112. Information can be transmitted through the ODN 108 bidirectionally, i.e., in both a downstream direction 116 and an upstream direction 118. The passive optical components 114 route the information transmitted through the ODN 108 to provide on-demand broadband access to the end users 106.

Passive optical components 114 (and even powered optical components) are typically sensitive to environmental conditions, such as rain, hail, dirt, impact, and the like. To protect passive optical components 114 (and powered optical components) from harm and increase operational life expectancy, it is not uncommon to house the passive optical components 114 (and powered optical components) in an enclosure 120. An exemplary enclosure 120 is depicted in FIG. 2. The enclosure 120 is shown suspended from a cable 122 extending between poles 124. However, the enclosure 120 may alternatively be located in an underground vault, attached to the pole 124, or attached to another object. The cable 122 includes optical fibers of the ODN 108 extending between the OLT 110 and the ONUs 112. It should be understood that other enclosure designs may be used in the PON 100. Instead of the domed enclosure illustrated herein, the enclosure 120 can also include a cabinet-style enclosure having a base with a hinged or translatable door, an underground enclosure located below the ground surface, an enclosure having one or more ruggedized connectors extending through the enclosure to permit optical coupling without requiring opening of the enclosure, or the like. These enclosures can be sized and shaped as desired to receive components described herein associated with edge computing.

Referring still to FIG. 2, the depicted enclosure 120 is a domed enclosure, including a base 126 and a cover 128 which is selectively engageable with the base 126. The cable 122 can be routed into the enclosure 120 to transmit optical signals into the enclosure 120. For example, the cable 122 can include two segments with ends 130 and 132 each routed into the enclosure 120. The ends 130 and 132 can be optically coupled together within the enclosure 120, e.g., through one or more passive optical components 114 (FIG. 1B) disposed within the enclosure 120. Optical signals transmitted through the cable 122 enter the enclosure 120 through one of the ends 130 or 132, pass through the passive optical component(s) 114, and exit the enclosure on the other end 130 or 132 of the cable 122.

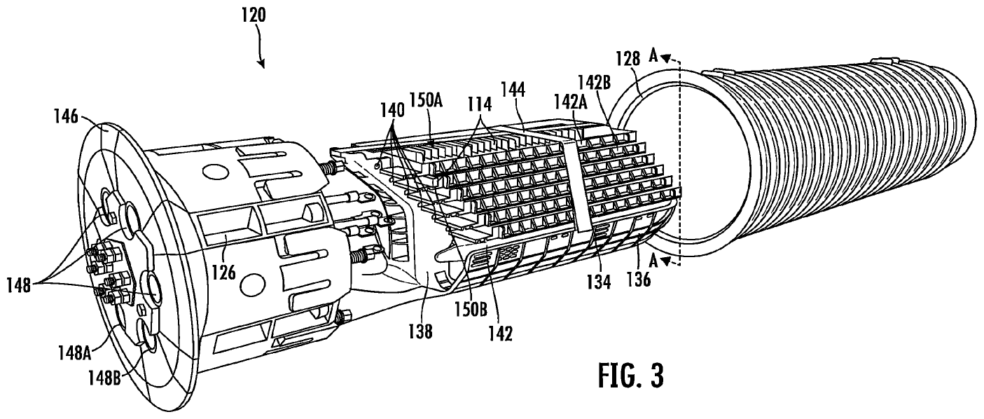

FIG. 3 illustrates an exemplary internal view of the enclosure 120 as seen in accordance with an exemplary embodiment with the cover 128 removed from the base 126 to reveal an internal volume 134 of the enclosure 120. The internal volume 134 houses the one or more passive optical components 114, protecting the components 114 from harsh environmental conditions.

The enclosure 120 can further include a basket 136 that extends into the cover 128 when the enclosure 120 is closed. A tray attachment structure 138 extends from the basket 136 and forms a plurality of receiving locations 140 engageable with a plurality of trays 142. In an embodiment, at least one of the trays 142, such as at least two of the trays 142, such as at least three of the trays 142, such as at least four of the trays 142, such as at least five of the trays 142, such as all of the trays 142 can move relative to the tray attachment structure 138. For example, the trays 142 may pivot with respect to the receiving locations 140 of the tray attachment structure 138. The trays 142 are depicted in a stored positioned, whereby the cover 128 is installable over the basket 136 to protect the internal volume 134. In this arrangement, the trays 142 are stacked with one another. In the stacked state, the trays 142 occupy minimal space. The tray(s) 142 may be selectively pivoted from the stacked state to allow operator access to an individual tray 142 disposed within the stack. A tray retention strap 144 may be used to selectively secure the trays 142 in the stored position.

The base 126 can include entrance structure 146 which allows for passage of one or more cables into and out of the internal volume 134. To prevent ingress of environmental contaminants, the entrance structure 146 can include one or more sealing structures 148. Each sealing structure 148 can receive a cable and form an environmental seal thereagainst to mitigate contamination of the internal volume 134. In an embodiment, the one or more sealing structures 148 can include a plurality of sealing structures 148 where at least one of the sealing structures 148 is interchangeable (or a component thereof is interchangeable) with another sealing structure 148 having the same or different configuration. In this regard, the sealing structure 148 can be changed in the event of damage or if a different type of sealing structure 148 is required, such as when the cable is changed to a new type of cable which has a different shape or size.

Cables 122 routed into the enclosure 120 through the entrance structure 146 can be optically coupled to one or more passive optical components 114 associated with each of the trays 142. For instance, a first cable (not illustrated) can extend through a first sealing structure 148A and one or more individual fibers associated with the first cable can be routed to a first tray 142A. The first tray 142A can include a splice tray 150A where a plurality of splices are made between the incoming fibers and a splitter (not illustrated). The output of the splitter can then be routed out of the enclosure 120, e.g., to one or more downstream ONUs 112. A second cable (not illustrated) can extend through a second sealing structure 148B and one or more individual fibers associated with the second cable can be routed to a second tray 142B. The second tray 142B can be similar to the first tray 142A, e.g., the second tray 142B can include a splice tray 150A where a plurality of splices are made between the incoming fibers and a splitter 150B. Without being limited to this particular arrangement, the arrangement and termination of cables and fibers may be repeated for each cable routed into the enclosure 120 as required based on the required set up of the ODN 108. In some instances, at least some of the trays 142 can include other components, such as other passive optical components like adapters, connectors, couplers, attenuators, isolators, circulators, filters, switches, optical add/drop multiplexers, or the like. These components can be selected based on the particular location of the enclosure 120 and the specific needs of the surrounding ODN 108. It should be understood that some enclosures 120 may not require full use of the tray attachment structure 138, i.e., some of the receiving locations 140 may not receive one of the trays 142 based on the specific needs of the surrounding ODN 108.

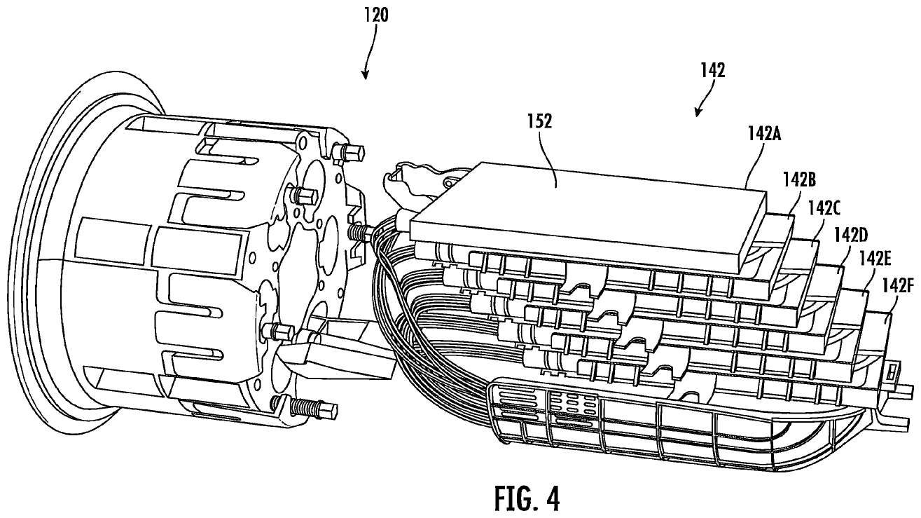

FIG. 4 illustrates a stack of trays 142 including a first tray 142A, a second tray 142B, a third tray 142C, a fourth tray 142D, a fifth tray 142E and a sixth tray 142F. The second, third, fourth, fifth and sixth trays 142B, 142C, 142D, 142E and 142F include passive optical components, e.g., splice trays or splitters. In certain instances, at least some of the second, third, fourth, fifth and sixth trays 142B, 142C, 142D, 142E and 142F can share a common architecture, e.g., include the same components or spatial arrangement. In other instances, at least one of the second, third, fourth, fifth and sixth trays 142B, 142C, 142D, 142E and 142F can be different from the others of the second, third, fourth, fifth and sixth trays 142B, 142C, 142D, 142E and 142F.

The first tray 142A depicted in FIG. 4 is different from the second, third, fourth, fifth and sixth trays 142B, 142C, 142D, 142E and 142F. The first tray 142A includes a powered component while the second, third, fourth, fifth and sixth trays 142B, 142C, 142D, 142E and 142F include passive components. It should be understood that the specific arrangement of trays 142A, 142B, 142C, 142D, 142E and 142F depicted in FIG. 4 is exemplary only. In other instances, the trays 142 can include a greater or lesser number of trays 142 which can be arranged in any similar or different arrangement as compared to that depicted in FIG. 4.

The powered component depicted in FIG. 4 is an edge compute node 152. The edge compute node 152 can perform one or more computational operations associated with the ODN 108. The edge compute node 152 can include a computing system having processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The edge compute node 152 can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. The one or more memories can include one or more tangible non-transitory computer readable instructions that, when executed by the one or more processors, cause the edge compute node 152 to perform one or more computational operations. The operations can include, for example, executing one or more of a plurality of processes of a computing system. For instance, the edge compute node 152 can include a compute node configured to run one or more processes of the plurality of processes. In some implementations, a process can include a plurality of function nodes (e.g., pure functions) connected by one or more directed edges that dictate the flow of data between the plurality of function nodes. A device can execute (e.g., via one or more processors, etc.) a respective plurality of function nodes to run a respective process.

For example, the plurality of function nodes can be arranged in one or more function graphs. A function graph can include a series of function nodes arranged (e.g., by one or more directed edges) in a pipeline, function graph, etc. The function nodes can include a computing function with one or more inputs (e.g., of one or more data types) and one or more outputs (e.g., of one or more data types). For example, the function nodes can be implemented such that they define one or more accepted inputs and one or more outputs. In some implementations, each function node can be configured to obtain one or more inputs of a single data type, perform a single function, and output one or more outputs of a single data type. The function nodes can be connected by one or more directed edges of a function graph, a subgraph of the function graph, etc. The one or more directed edges can dictate how data flows through the function graph, subgraph, etc. A device can be configured to execute one or more function graphs to run one or more processes of the plurality of processes. In some implementations, one or more of the plurality of processes can include containerized services (application containers, etc.). For instance, each process can be implemented as a container (e.g., docker containers, etc.). For example, the plurality of processes can include one or more containerized processes abstracted away from an operating system associated with a respective device.

FIG. 5 illustrates an exemplary schematic view of a remote computing network 154 utilizing an edge compute network 156. The remote computing network 154 is used by internet of things (IoT) devices 158 such as smart phones, tablets, smart locks, smart thermostats, smart lighting, smart security, smart appliances, smart vehicles, autonomous vehicle, and other devices which are connected to the internet and store data. To offload processing and increase device performance, the IoT devices 158 can communicate with remote processers 160, e.g., data centers 162 and clouds 164, where processing operations can be performed. By offloading processing to the remote processors 160, the IoT devices 158 can run more efficiently or perform functionality that is otherwise impossible given local programming limitations of the IoT device 158, data limitations of the IoT device 158, processing power limitations, or the like. By way of example, high-definition video (e.g., 4K video, 5K video, 8K video, etc.) requires significant computational processing power. By offloading such video processing to a remote processor 160 with greater capability (e.g., greater processing power or video processing functionality), the IoT device 158 may continue performing at desired speeds and output capacity.

In some instances, processing is split between the IoT device 158 and the remote processor 160. For example, some processing can be performed at the IoT device 158 and other processing can be performed at the remote processor 160. In other instances, the entire processing operation is fully offloaded to the remote processor 160. Offloading typically requires transmission of large packets of information between the IoT device 158 and the remote processor 160. The physical distance between the IoT device 158 and the remote processor 160 can throttle speed at which processing is completed. Over large distances, latency may increase beyond acceptable thresholds.

For example, autonomous vehicles (an exemplary type of IoT device 158) may communicate with remote processors 160 which perform one or more computational processes associated with autonomous travel. As the autonomous vehicle travels on a road, one or more onboard processors of the autonomous vehicle can relay information relating to the autonomous vehicle (such as route information, sensor information, or the like) to a remote antenna, e.g., using a wireless communication protocol such as high-speed packet access (HSPA), long-term evolution (LTE), LTE-A, New Radio (NR, often referred to as 5G), LTE-A Pro, or the like. The relayed information is then transmitted from the remote antenna to the remote processor 160 for processing. After processing is completed, return information (such as route guidance, driver notifications and warnings, or the like) is transmitted from the remote processor 160 to the remote antenna (or another antenna as the autonomous vehicle may at such time be located closer to a different antenna) and back to the autonomous vehicle. The autonomous vehicle can then take action, e.g., suggest alternative route guidance, in response to the returned information. In the case of time-sensitive actions, any latency occurring as a result of the distance information must travel to get to and from the remote processor 160 is unacceptable and can result in the loss of life.

As another example, smart agricultural systems including autonomous or semi-autonomous tractors may communicate with the remote processor 160 to inform route guidance when performing field operations like seeding, fertilizing, harvesting, or the like. Any latency when approaching obstacles in the field or the perimeter of the field may cause the tractor to impact the obstacle, operate too close to the perimeter of the field, or even leave the field. In certain instances, a plurality of autonomous vehicles may operate simultaneously in the field. For example, a harvester and collection vehicle can move in sync across the field to harvest and collect crops. Communication latency when accessing the remote processor 160 may result in the vehicles drifting relative to one another which in turn can negatively impact collection efficiency or even result in the vehicles impacting one another.

As yet another example, the practices of remote medicine and telemedicine are gaining popularity. In some instances, medical practices may be incorporated into ambulatory services, whereby ambulances provide onboard healthcare workers with access to previously inaccessible services. For example, video and advanced health monitoring in the ambulance may be used in real time to diagnose and treat patients using remote doctors and processing resources. Communication latency of video and health monitoring data may result in decreased treatment effectiveness.

To mitigate latency, the edge compute network 156 can be interposed between the IoT device(s) 158 and the remote processor 160, i.e., the edge compute network 156 can be at the edge of the remote computing network 154 at a location physical near the IoT device 158. The edge compute network 156 can perform processing functions which require low latency and/or occupy high data transmission rates which would otherwise slow network speed. The edge compute network 156 can provide functional processing, including, e.g., realtime data processing and analytics 166, data caching, buffering and optimization 168, machine to machine communicating 170, or the like.

The edge compute node 152 depicted in FIG. 4 may be part of the edge compute network 156. In particular, the edge compute node 152 may be configured to perform functional processing at the edge of the remote computing network 154. The functional processing may be different for different areas of the remote computing network 154. For example, edge compute nodes 152 disposed near roadways may be programmed, e.g., include software and processing capability, to provide guidance information and to interconnect autonomous vehicles with one another for inter-vehicle communication. Edge compute nodes 152 disposed near roadways may further be programmed to provide ambulatory services which better facilitate medical treatment. Meanwhile, edge compute nodes 152 disposed near agricultural areas may be programmed, e.g., include software and processing capability, to provide agricultural management and oversight functionality between various autonomous agricultural tools. Similarly, edge compute nodes 152 disposed near manufacturing plants may be programmed, e.g., include software and processing capability, to provide management and oversight of autonomous robots used in assembly lines. Each of these edge compute nodes 152 can be preprogrammed at a factory or aftermarket site and delivered to desired locations based on use case and need. In some instances, a plurality of edge compute nodes 152 can be combined together, i.e., used at the same time, in areas where multiple different use cases and needs are required.

Given the prevalence of enclosures 120 already in use in the field, i.e., at every location where optical components 90, 96 and 114 are located (FIGS. 1A and 1B), inclusion of edge compute nodes 150 into enclosures 120 increases in-field computing density, thereby reducing latency times associated with processing using traditional remote processors 160 which are often spaced apart from the loT device 158 (FIG. 5) by miles and thus additional milliseconds (ms) of latency. Additionally, inclusion of edge compute nodes 150 into enclosures 120 reduces fiber backhaul. Moreover, enclosures 120 are already in the field and connected to optical fibers in the ODN 108 (FIG. 1B). As a result, use of the enclosure 120 for housing the edge compute node 152 allows for faster broadband speeds without requiring installation of new equipment which can be time consuming, require significant capital expense and labor, and rely on advanced and multi-governmental permitting which can be difficult to obtain.

In some instances, the edge compute node 152 can be installed into the ODN 108 during installation of the enclosure 120. That is, the edge compute node 152 can be installed in the enclosure 120 when the enclosure 120 is initially deployed and installed in the field. By way of non-limiting example, this may occur when a new subdivision is being built and the ODN 108 is expanded to cover the new end users 106, when a new office building is erected, or the like. In other instances, the edge compute node 152 can be retrofitted into the ODN 108 using existing enclosures 120 which were previously installed. Retrofitting of the edge compute node 152 into existing enclosures 120 will now be described in greater detail.

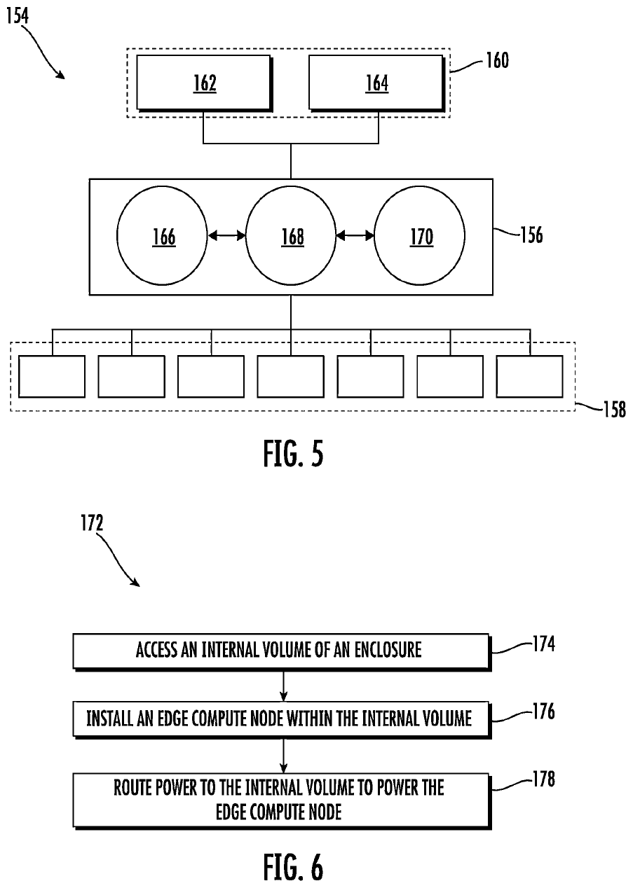

FIG. 6 is a flowchart of a method 172 of upgrading an optical fiber network by retrofitting an edge compute node 152 into an existing enclosure 120. The method 172 generally involves a step 174 of accessing the internal volume 134 of the enclosure 120. By way of non-limiting example, access to the internal volume 134 may be achieved by removing the cover 128 from the base 126. In some instances, access to the internal volume 134 may be achieved while the enclosure 120 remains coupled to its supporting structure, e.g., the cable 122 (FIG. 2). In other instances, the enclosure 120 is first removed from supporting structure before accessing the internal volume 134.

After accessing the internal volume 134, the method 172 can further include a step 176 of installing the edge compute node 152 within the internal volume 134 of the enclosure 120. In an embodiment, the step 176 of installing the edge compute node 152 can involve installation of a single edge compute node 152. In another embodiment, the step 176 of installing the edge compute node 152 can involve installation of a plurality of edge compute nodes 152. In an embodiment, at least two of the plurality of edge compute nodes 152 can have a common processing functionality, i.e., perform the same computations. In another embodiment, at least two of the plurality of edge compute nodes 152 can have different processing functionality as compared to one another. For instance, by way of non-limiting example, a first edge compute node installed in the enclosure 120 may be used for route guidance for autonomous vehicles in the area and a second edge compute node installed in the same enclosure 120 can be used for agricultural management of a nearby farm that uses one or more autonomous vehicles.

In an embodiment, installation of the edge compute node 152 can be performed by installing a tray having the edge compute node 152 in lieu of one of the trays 142 (FIG. 4). The tray having the edge compute node 152 may have one or more similar or different characteristics as compared to existing trays 142. In an embodiment, the tray having the edge compute node 150 can be similarly sized or shaped as compared to the existing trays 142. In another embodiment, the tray having the edge compute node 150 can be differently sized or shaped as compared to the existing trays 142. In instances where all of the receiving locations 140 are currently occupied by existing trays 142 (or where an ideal location for the edge compute node 152 is occupied by an existing tray 142), one of the existing trays 142 can first be removed from its respective receiving location 140 and then replaced by the tray having the edge compute node 152. In other instances where a receiving location 140 is vacant, the tray with the edge compute node 152 can be installed without requiring removal of any existing trays 142. During the initial installation and setup of the enclosure 120, technicians may install trays 142 back-to-front, i.e., from the basket 136 forward. As a result, available receiving locations 140 are often disposed on a near side of the tray attachment structure 138, making retrofit installation easier. However, installation of the tray with the edge compute node 152 at a non-forwardmost receiving location 140 may be readily achievable, e.g., by pivoting the overlying trays 142 out of the way to expose a space for the tray with the edge compute node 152.

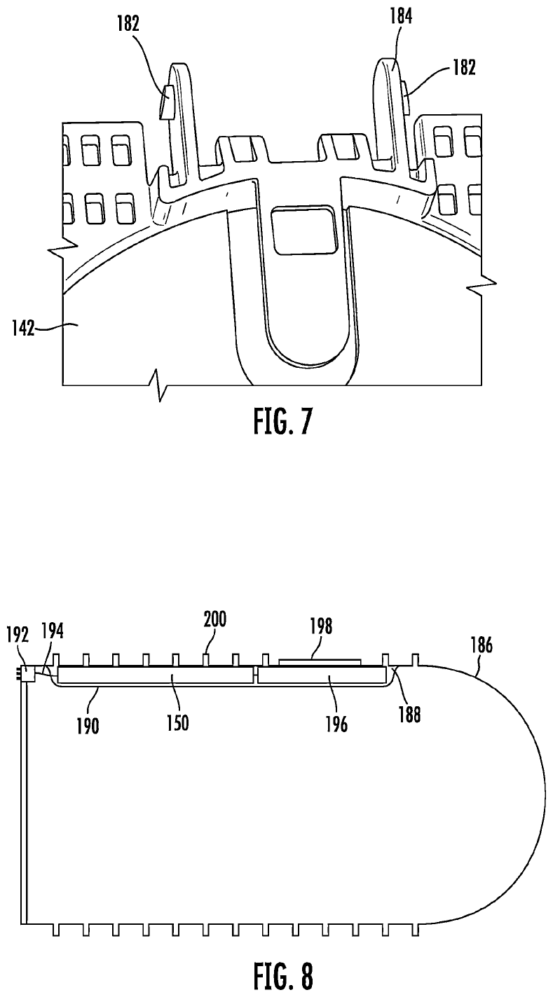

Referring to FIG. 7, and by way of non-limiting example, the trays 142 can include projections 182 which seat within openings (not illustrated) of the receiving locations 140. The projections 182 may be disposed on flexible flanges 184 that deflect when squeezed. To remove or add a tray 142 at one of the receiving locations 140, the technician flexes the flanges 184 and moves the tray 142 until the projections 182 are aligned with the openings of the receiving locations 140. Once aligned with the openings, the technician releases the flanges 184 which return to their initial state, causing the projections 182 to be retained in the openings.

Once the tray with the edge compute node 152 is installed, the edge compute node 152 can be optically coupled to the ODN 108. This can include, for example, routing optical fibers of the cable 122 (FIG. 2) to the edge compute node 152. Many, if not all, of the optical fibers routed to the edge compute node 152 are already disposed within the enclosure 120. For example, enclosures 120 often include excess fiber areas where excess optical fiber is looped for slack and easier servicing of the optical fiber. This looped excess fiber can be tapped, split, spliced, or the like and routed to the edge compute node 152. Alternatively, the optical fibers can be accessed from existing splices at splice trays 142, by using fibers stored at parking locations within the enclosure, by routing new fibers into the enclosure 120, or the like. In some instances, where an existing tray 142 is being replaced by a tray having the edge compute node 152, it may be desirable to use the fibers associated with at least some of the splices that were previously retained by the existing tray 142.

Referring again to FIG. 6, installation of the edge compute node 152 at step 176 can alternatively be performed by switching (i.e., replacing) an element of the enclosure 120 with a replacement element having the edge compute node 152 integrated therewith. For example, the cover 128 (i.e., the existing cover) can be switched with an edge compute node cover 186 (FIG. 8) having the edge compute node 152 integrated therewith.

Referring to FIG. 8, the edge compute node cover 186 can include the edge compute node 152. For example, the edge compute node 152 can be attached to an inner surface 188 of the edge compute node cover 186. The edge compute node 152 can be disposed within a protective structure 190 of the edge compute node cover 186. The protective structure 190 can include, for example, a pocket which receives the edge compute node 152, an encapsulating material surrounding the edge compute node 152, a protective shield surrounding the edge compute node 152, or the like. Optical connection of the edge compute node 152 to the ODN 108 can be performed in a manner similar to that described above with respect to the trays 142.

In other embodiments, the edge compute node 152 can be coupled to the ODN 108 using a connector 192 that is coupled to the edge compute node 152 by a cable 194 and supported by the edge compute node cover 186. The connector 192 may be a blind mate connector which mates with a complementary blind mate connector component located, for example, on the base 126. Optical connection between the connector and complementary connector can occur when the edge compute node cover 186 is joined to the base 126. In this regard, the edge compute node 152 is optically coupled to the ODN 108 when the edge compute node cover 186 is joined to the base 126 and optically uncoupled from the ODN 108 when the edge compute node cover 186 is removed from the base 126.

Referring again to FIG. 6, the method 172 can further include a step 178 of routing power to the internal volume 134 to power the edge compute node 152. In some instances, step 178 can be performed prior to installing the edge compute node 152 within the internal volume 134 at step 176. In other instances, step 178 can be performed simultaneously with or after completion of step 176.

Most in-line enclosures in optical networks (e.g., enclosures 120 in PON 100) are passive, i.e., include only passive optical components 114. In this regard, it is atypical for enclosures 120 already installed in the field to have a power source enter or be disposed within the internal volume 134. However, the edge compute node 152 requires power to operate. Since the sealing structures 148 (FIG. 3) of PON enclosures 120 are not intended for use with powered components, it may be necessary to change at least one of the sealing structures 148 to accommodate power cables or hybrid cables. By way of non-limiting example, one of the sealing structures 148, such as the first sealing structure 148A, can be removed from the base 126 and replaced by a specialized sealing structure 148 which includes opening(s) sized and shaped to receive and seal a power cable and/or any other cables necessary to operate the edge compute node 152.

For embodiments using the edge compute node cover 186, the connector 192 can include power connectors, such as a multi-pin connector, which automatically couple with the complementary blind mate connector located on the base 126 when the edge compute node cover 186 is installed on the base 126. In this regard, the edge compute node 152 automatically receives electrical power when the edge compute node cover 186 is joined to the base 126 and the power supply is disconnected when the edge compute node cover 186 is removed from the base 126.

In an embodiment, providing power to the internal volume 134 at step 178 can be performed by using an energy source 196. By way of example, the energy source 196 can include a rechargeable battery in electrical communication with the edge compute node 152. In some instances, the energy source 196 is electrically coupled to an external power source, e.g., a copper wire running next to, or inside, cable 122. In other instances, the energy source 196 is electrically coupled to a renewable power source 198, such as a photovoltaic panel, a wind turbine, a thermocouple, or the like. The renewable power source 198 can be integrated into the edge compute node cover 186. For example, the renewable power source 198 can be overmolded, attached with a fastener (e.g., a threaded fastener, a non-threaded fastener, a crimp, or the like), attached through interference fit, attached by an adhesive, or the like.

In an embodiment, the edge compute node cover 186 can include a heat control element 200, such as a heat sink with fins, fans, or the like to radiate heat from the edge compute node 152 and prevent overheating.

In an embodiment, the energy source 196 and edge compute node 152 can be part of a shared or common structure. In this regard, the edge compute node 152 and energy source 196 can appear to be a single unit during installation. In other embodiments, the energy source 196 may include a discrete component separate from the edge compute node 152. In some instances, like when the edge compute node 152 is part of the tray stack 142, the edge compute node 152 and energy source 196 may be provided to the installation technician as a common structure with engagement structures, e.g., projections 182 disposed on flexible flanges 184, which the technician installs to one of the receiving locations 140 of the tray attachment structure 138. In this regard, the installation technician can install the edge compute node 152 and all elements necessary to operate the edge compute node 152 simultaneously with minimal effort or time.

In some instances, the installation technician may install a plurality of edge compute nodes 152 in a particular enclosure 120 using the same, similar, or different attachment protocol operations for each edge compute node 152. In other instances, the installation technician may not install edge compute nodes 152 in all of the enclosures 120 in the ODN 108. As described above, the PON 100 includes frequent use of enclosures 120 within the ODN 108. Each of these enclosures 120 represents a potential location for housing one or more edge compute nodes 152. However, it may not be necessary for all enclosures 120 in the ODN 108 to house one of the edge compute nodes 152. In this regard, the method 172 of upgrading the optical fiber network by retrofitting edge compute nodes 152 into existing enclosures 120 may include installing edge compute nodes 152 in less than all of the plurality of enclosures 120. The ODN 108 may include n enclosures, where n is at least 2, and x edge compute nodes 152, where x is less than n. For example, for a given location, n may be 100 and x may be less than 50, such as less than 40, such as less than 30, such as less than 20, such as less than 10, such as less than 5, such as less than 4, such as less than 3, or such as less than 2. The edge compute node density may be less than five per ten enclosures 120 (i.e., less than five edge compute nodes 152 per every ten enclosures 120), such as less than 4 per ten enclosures 120, such as less than 3 per ten enclosures 120, such as less than 2 per ten enclosures 120, such as less than 1 per ten enclosures 120, such as less than 5 per hundred enclosures 120, such as less than 4 per hundred enclosures 120, such as less than 3 per hundred enclosures 120, such as less than 2 per hundred enclosures 120, such as less than 1 per two hundred enclosures 120.

In some instances, considerations may be made when selecting enclosures 120 within the ODN 108 for receipt of edge compute nodes 152. Exemplary considerations include anticipated use-density of the nearby area (i.e., how much edge data processing may be required in the vicinity of the enclosure 120), proximity to wireless communication nodes where wireless signals are transmitted by IoT devices 158 that might require remote processing, existing available space within the enclosure 120 (e.g., are there any unused receiving locations 140), ease of accessing the enclosure 120, and the like.

In an embodiment, the ODN 108 can be tracked, e.g., mapped, to provide information regarding the statuses of the enclosures 120. For example, a number of unused receiving locations 140 per enclosure can be recorded and a log of available receiving locations 140 at each enclosure can be maintained. In some instances, logs of available receiving locations 140 within the ODN 108 can be used by a processor to inform which enclosures 120 should receive edge compute nodes 152. The processor can further account for any one or more other considerations, such as those provided above.

In an embodiment, the plurality of edge compute nodes 152 can be spread between different enclosure types. For example, a first edge compute node 152 in the ODN 108 can be disposed in a domed enclosure like that shown herein, a second edge compute node 152 can be disposed in a cabinet enclosure having a hinged door, and a third edge compute node 152 can be disposed in an enclosure having one or more ruggedized connectors extending through the enclosure which allow for optical coupling without requiring exposure of the internal volume 134 to the surrounding environment.

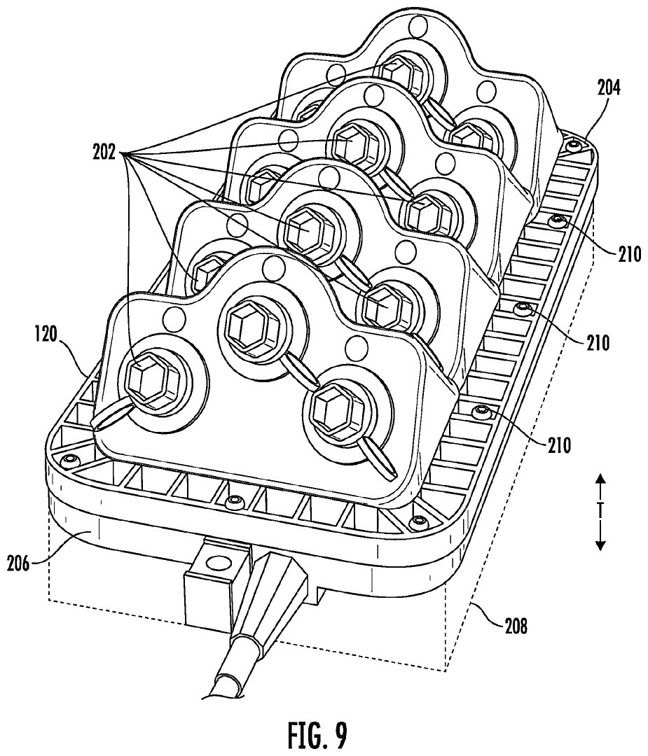

Similar to retrofitting the enclosure 120 by replacing the cover 128 with the edge compute node cover 186, in an embodiment retrofitting the edge compute node 152 in certain types of enclosures 120 can involve replacing a component of the enclosure 120 with an edge compute node-capable component. For example, referring to FIG. 9, enclosures 120 with ruggedized connectors 202 extending through the enclosure body 204 often include thin dimensions in direction T to minimize occupied space of the enclosure body 204. To increase the dimensions of the enclosure 120 to accommodate the edge compute node 152, a back plate 206 of the enclosure body 204 can be replaced with an edge compute node back plate 208 (shown by dashed lines) sized and shaped to house the edge compute node 152 within the internal volume 134 of the enclosure 120. The internal volume 134 of the back plate 208 can include a receiving area configured to house the edge compute node 152. The back plate 208 can further accommodate any necessary components associated with the edge compute node 152, such as an energy source, a wireless receiver/transmitter, a blind mate connector, a heat control source, a photovoltaic panel, or the like. In an embodiment, the dimension of the back plate 208 in the dimension T can be larger than the dimension of the back plate 206 in the dimension T. To replace the back plate 206 with the back plate 208, fasteners 210 can be removed, the back plate 208 can be swapped into position, and the fasteners 210 can be reinstalled. When using blind mate connectors, optically coupling the edge compute node 152 to the ODN 108 or electrically coupling the edge compute node 152 to power can occur when the back plate 208 is properly aligned and positioned relative to other features of the enclosure body 204.

Networks, systems, methods and components described herein can increase effectiveness of current broadband solutions by allowing for rapid expansion of edge computing power. Embodiments described herein allow for the use of existing or new infrastructure to position remote processors (i.e., edge compute nodes) closer to IoT devices, reducing latency and increasing computing power to end users. Embodiments described herein utilize passive optical network architecture to position remote processors (i.e., edge compute nodes) at locations with high processing demand without requiring expensive new facilities. Embodiments described herein can allow for upgrading of the passive optical network architecture by providing a modular approach to retrofitting edge compute nodes within existing enclosures located on an optical distribution network of the passive optical network. With existing access to the optical distribution network at the enclosures, such retrofitting is easy, quick, and cost-effective.

As technology continues to drive demand for low latency, remote processing, there is an increasing demand for modularity and retrofit capability. By way of example, as autonomous vehicles grow in popularity, so too does the amount of information being transmitted in optical distribution networks. For example, sensor data from autonomous vehicles may be offloaded to remote processors capable of performing advanced processing using specialized algorithms not available to the autonomous vehicle itself. By localizing processing power at highways and roadways of heavy travel, autonomous vehicles can more quickly access remote processing power. As routes of travel for autonomous vehicles change and processing power demands shift, e.g., as autonomous vehicles penetrate deeper into rural areas and operate at more remote locations, it would be desirable to quickly and easily retrofit existing infrastructure within those areas with edge compute power for remote processing. Conversely, areas with decreasing travel and processing power demands (e.g., closed highways or roadways under construction with limited use) may no longer need localized edge compute power. These areas can have their edge compute power removed or reduced and instead replaced with other systems or architecture advantageous to the local needs. Advantageously, embodiments described herein allow for broadband to achieve the next level of speed and on-demand broadband delivery the market demands.

Further aspects of the invention are provided by one or more of the following embodiments:

Embodiment 1. An optical fiber network comprising: an optical line terminal; an optical network unit; an optical fiber network extending between the optical line terminal and the optical network unit; an enclosure disposed along the optical fiber network, wherein the enclosure comprises: a base; a cover, wherein the base and cover selectively enclose an internal volume of the enclosure; a tray disposed in the internal volume; and an edge compute node coupled to the tray and in optical communication with the optical line terminal and the optical network unit.

Embodiment 2. The network of embodiment 1, wherein the tray comprises a first tray, wherein the enclosure further comprises a second tray stacked on the first tray, and wherein the second tray supports a splice tray, an adapter, or a splitter.

Embodiment 3. The network of any one of the preceding embodiments, wherein the enclosure further comprises an energy source disposed in the internal volume and configured to power the edge compute node.

Embodiment 4. The network of embodiment 3, wherein the energy source comprises a rechargeable battery in electrical communication with a photovoltaic panel.

Embodiment 5. The network of any one of embodiments 3 or 4, wherein the energy source is disposed on the tray or another tray disposed in the internal volume.

Embodiment 6. The network of any one of the preceding claims, wherein the edge compute node is retrofit to the enclosure.

Embodiment 7. The network of embodiment 6, wherein retrofitting the edge compute node includes routing power to the internal volume and coupling power to the edge compute node, and wherein other components of the enclosure are passive.

Embodiment 8. An enclosure for an optical fiber network, the enclosure comprising: a housing selectively enclosing an internal volume which houses one or more passive optical components; and an edge compute node disposed in the internal volume and configured to be in optical communication with an optical line terminal and an optical network unit of the optical fiber network.

Embodiment 9. The enclosure of embodiment 8, wherein the edge compute node is coupled to a tray moveably coupled to a tray attachment structure, wherein the enclosure further comprises a second tray stacked on the tray, and wherein the second tray supports at least one of the one or more passive optical components.

Embodiment 10. The enclosure of embodiment 9, wherein the enclosure further comprises an energy source disposed in the enclosure and configured to power the edge compute node, and wherein the energy source is coupled to the tray.

Embodiment 11. The enclosure of embodiment 8, wherein the housing comprises a base and an edge compute node cover, wherein the edge compute node is part of the edge compute cover, and wherein uncoupling the edge compute node cover from the base disconnects the edge compute node from a power source associated with the enclosure.

Embodiment 12. The enclosure of any one of embodiments 8 to 11, wherein the edge compute node is retrofit to the enclosure, and wherein retrofitting the edge compute node comprises: installing the edge compute node after the enclosure is disposed in the optical fiber network; and routing power to the internal volume to power the edge compute node.

Embodiment 13. A method of upgrading an optical fiber network, the method comprising: accessing an internal volume of an enclosure disposed along the optical fiber network, wherein the enclosure houses one or more passive optical components; installing an edge compute node within the internal volume; and routing power to the internal volume to power the edge compute node.

Embodiment 14. The method of embodiment 13, wherein installing the edge compute node is performed by inserting a tray into the internal volume and coupling the tray with a tray attachment structure disposed in the internal volume, and wherein the tray houses the edge compute node.

Embodiment 15. The method of embodiment 14, wherein installing the edge compute node further comprises removing an existing tray disposed in the internal volume and replacing the existing tray with the tray having the edge compute node.

Embodiment 16. The method of embodiment 13, wherein installing the edge compute node is performed by switching an existing cover of the enclosure with an edge compute node cover, and wherein the edge compute node is coupled to the edge compute cover.

Embodiment 17. The method of embodiment 16, wherein power is provided to the edge compute node by electrically connecting a blind mate power connector including a first connector disposed on the edge compute node cover and a second connector disposed on a base of the enclosure, and wherein connecting the blind mate power connector occurs when the edge compute node cover is moved towards the base.

Embodiment 18. The method of any one of embodiments 16 or 17, wherein the edge compute node cover comprises a heat control element.

Embodiment 19. The method of any one of embodiments 13 to 18, wherein the enclosure is one of a plurality of enclosures, and wherein upgrading the optical fiber network comprises installing edge compute nodes in less than all of the plurality of enclosures.

Embodiment 20. The method of any one of embodiments 13 to 19, wherein routing power to the internal volume comprises installing a sealing structure on the enclosure, the sealing structure receiving and sealing cables associated with the edge compute node, and wherein the sealing structure is different than one or more other sealing structures associated with the passive optical components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An optical fiber network comprising:
an optical line terminal;
an optical network unit;
an optical fiber network extending between the optical line terminal and the optical network unit;
an enclosure disposed along the optical fiber network, wherein the enclosure comprises:
a base;
a cover, wherein the base and cover selectively enclose an internal volume of the enclosure;
a tray disposed in the internal volume; and
an edge compute node coupled to the tray and in optical communication with the optical line terminal and the optical network unit.

2. The network of claim 1, wherein the tray comprises a first tray, wherein the enclosure further comprises a second tray stacked on the first tray, and wherein the second tray supports a splice tray, an adapter, or a splitter.

3. The network of claim 1, wherein the enclosure further comprises an energy source disposed in the internal volume and configured to power the edge compute node.

4. The network of claim 3, wherein the energy source comprises a rechargeable battery in electrical communication with a photovoltaic panel.

5. The network of claim 3, wherein the energy source is disposed on the tray or another tray disposed in the internal volume.

6. The network of claim 1, wherein the edge compute node is retrofit to the enclosure.

7. The network of claim 6, wherein retrofitting the edge compute node includes routing power to the internal volume and coupling power to the edge compute node, and wherein other components of the enclosure are passive.

8. An enclosure for an optical fiber network, the enclosure comprising:
a housing selectively enclosing an internal volume which houses one or more passive optical components; and
an edge compute node disposed in the internal volume and configured to be in optical communication with an optical line terminal and an optical network unit of the optical fiber network.

9. The enclosure of claim 8, wherein the edge compute node is coupled to a tray moveably coupled to a tray attachment structure, wherein the enclosure further comprises a second tray stacked on the tray, and wherein the second tray supports at least one of the one or more passive optical components.

10. The enclosure of claim 9, wherein the enclosure further comprises an energy source disposed in the enclosure and configured to power the edge compute node, and wherein the energy source is coupled to the tray.

11. The enclosure of claim 8, wherein the housing comprises a base and an edge compute node cover, wherein the edge compute node is part of the edge compute cover, and wherein uncoupling the edge compute node cover from the base disconnects the edge compute node from a power source associated with the enclosure.

12. The enclosure of claim 8, wherein the edge compute node is retrofit to the enclosure, and wherein retrofitting the edge compute node comprises:
installing the edge compute node after the enclosure is disposed in the optical fiber network; and
routing power to the internal volume to power the edge compute node.

13. A method of upgrading an optical fiber network, the method comprising:
accessing an internal volume of an enclosure disposed along the optical fiber network, wherein the enclosure houses one or more passive optical components;
installing an edge compute node within the internal volume; and
routing power to the internal volume to power the edge compute node.

14. The method of claim 13, wherein installing the edge compute node is performed by inserting a tray into the internal volume and coupling the tray with a tray attachment structure disposed in the internal volume, and wherein the tray houses the edge compute node.

15. The method of claim 14, wherein installing the edge compute node further comprises removing an existing tray disposed in the internal volume and replacing the existing tray with the tray having the edge compute node.

16. The method of claim 13, wherein installing the edge compute node is performed by switching an existing cover of the enclosure with an edge compute node cover, and wherein the edge compute node is coupled to the edge compute cover.

17. The method of claim 16, wherein power is provided to the edge compute node by electrically connecting a blind mate power connector including a first connector disposed on the edge compute node cover and a second connector disposed on a base of the enclosure, and wherein connecting the blind mate power connector occurs when the edge compute node cover is moved towards the base.

18. The method of claim 16, wherein the edge compute node cover comprises a heat control element.

19. The method of claim 13, wherein the enclosure is one of a plurality of enclosures, and wherein upgrading the optical fiber network comprises installing edge compute nodes in less than all of the plurality of enclosures.

20. The method of claim 13, wherein routing power to the internal volume comprises installing a sealing structure on the enclosure, the sealing structure receiving and sealing cables associated with the edge compute node, and wherein the sealing structure is different than one or more other sealing structures associated with the passive optical components.
